(19) United States
(12) Patent Application Publication
(10) Pub. No.: US 2013/0160319 A1
(43) Pub. Date: Jun. 27, 2013

(54) METHOD AND APPARATUS FOR DRYING PLANT MATERIAL

(71) Applicants: Michael Jacob, Weimar (DE); Tilo Kloeppel, Weimar-Taubach (DE); Melanie Guttzeit, Weimar (DE); Reinhard Boeber, Weimar (DE)

(72) Inventors: Michael Jacob, Weimar (DE); Tilo Kloeppel, Weimar-Taubach (DE); Melanie Guttzeit, Weimar (DE); Reinhard Boeber, Weimar (DE)

(73) Assignee: GLATT INGENIEURTECHNIK GMBH, Weimar (DE)

(21) Appl. No.: 13/821,660

(22) PCT Filed: Sep. 5, 2011
(86) PCT No.: PCT/EP2011/004462

§ 371 Date: Mar. 8, 2013

(30) Foreign Application Priority Data
Sep. 10, 2010 (DE) 10 2010 045 064.2

(51) Int. Cl. F26B 7/00

(52) U.S. Cl. CPC F26B 7/00
USPC 34/381; 34/443; 34/474; 34/406; 34/237; 34/60

(57) ABSTRACT

The invention relates to a method and to an accompanying facility (1) for drying plant material (19), such as, for example, fruits, spices, plants, herbs and the like, by means of a stream of drying gas which is supplied to a drying installation. The method according to the invention is distinguished by the fact that the material to be dried is distributed to a plurality of trays (15-17) of the drying installation (1), which trays are arranged one above the other and through which gas can flow, where each tray is supplied with a portion (10, 11) of refreshed and conditioned drying gas so that an almost uniform drying rate of the material to be dried is obtained on the individual trays. The facility according to the invention is composed of a plurality of trays (13, 17) arranged one above the other in the process space (3) of the drying installation (1) so that a first portion (10) of the drying gas can flow through them, they are divided in each case into a plurality of segments (12) and they have assigned to them, underneath the segments (12) of the respective individual trays (16, 17), in each case a marginal channel (14), a central channel (13) and a transverse channel (18), for supplying a second portion (11) of a drying gas.

The invention relates to a method for drying of plant material, such as, for example, fruits, spices, plants, herbs, and the like, having the characteristics mentioned in the preamble of claim 1, and to a related apparatus, having the characteristics mentioned in the preamble of claim 8.

Drying of foods and of plant material, such as spices, herbs, or fruits, usually takes place by means of freeze-drying. A reactor through which gas flows is known from CH 681 564 A5, in which reactor the material is dried by means of freeze-drying.

It is disadvantageous in the freeze-drying of plant material that a high investment demand is required for drying. Furthermore, the systems for freeze-drying require a large amount of space. In order to dry fruits by means of freeze-drying, long dwell times of the material in the apparatus are necessary. Freeze-drying of fruits can only be carried out for fruit in small pieces. Furthermore, an aroma loss of the fruits dried in this manner is unavoidable.

A method for drying of a particulate material and a device for implementing the method are known from DE 35 16 967 C2. In this connection, drying of materials preferably takes place in fluidized beds, making use of sublimation. The air for drying is circulated. Furthermore, drying of the material under vacuum conditions is described.

It is disadvantageous that only products that can be fluidized, in other words can be fluidized by a gas, are processed in fluidized bed apparatuses. The products are subject to great mechanical stress as the result of this “fluidization,” and therefore soft or sensitive products, such as fruits, for example, are deformed or damaged. Furthermore, the fruits have a tendency to stick together (caking), and therefore cannot be dried in the fluidized bed state. Fibrous or irregularly structured products (for example herbs, plants, plant parts, fruits) easily hook into one another and therefore are also unsuitable for drying in a fluidized bed.

Furthermore, it is known to carry out drying of fruits by means of a vacuum belt dryer. It is disadvantageous, in this connection, that the belt dryers require a lot of space, because of their size and construction, and this results in high investment costs. Furthermore, the belt dryers have mechanically moving parts that require complicated design effort, on the one hand, and are subject to great wear, on the other hand. Product contamination is unavoidable as the result of drying of fruits on belt dryers.

It is the task of the invention to create a method and a related apparatus for drying of plant material, such as, for example, fruits, spices, plants, herbs, and the like, with which method/apparatus gentle and cost-advantageous drying of the material to be treated, at the most uniform possible drying speed, takes place in the entire region of the process space.

This task is accomplished, according to the invention, for the method, by means of the characterizing features of claim 1, and for the apparatus, by means of the characterizing features of claim 8.

The method according to the invention is characterized in that the material to be dried is distributed onto multiple trays of the drying apparatus disposed one on top of the other, through which gas can flow, whereby each tray has part of the fresh and conditioned drying gas passed to it, so that an almost uniform drying speed of the material to be dried is achieved on the individual trays.

The apparatus according to the invention consists of multiple trays that lie one on top of the other in a process space of the drying apparatus, through which a first part of a drying gas can flow, which trays are divided into multiple segments, in each instance, and with an edge channel, a central channel, and a transverse channel disposed on them, in each instance, to supply a second part of a drying gas below the segments of the individual trays, in each instance.

The advantage of the solution according to the invention consists in that because of the guidance of the drying gas, the material to be dried does not have to be fluidized by the drying gases. As a result, a reduction in the mechanical stress on the products to be dried occurs, so that even fibrous or irregularly shaped products, or, in part, even whole fruits are accessible to the drying process. By means of the solution according to the invention, intensive and gentle drying of the material takes place. In this way, sticking of the fruits to one another and hooking of fibrous or irregularly structured products into one another is avoided.

A further advantage is that the drying speed on the individual trays, in each instance, is made more uniform by means of at least partial mixing of the moist exhaust air from the individual drying segments with fresh air. In this way, it is possible to dimension the air flow through the individual trays required for drying only in accordance with the required evaporation output. An air amount for fluidizing the materials to be treated is not required.

Further advantageous embodiments are described in the dependent claims; they will be explained in the description, along with their effect.

The invention will be described in greater detail below, using an exemplary embodiment. The related drawings show:

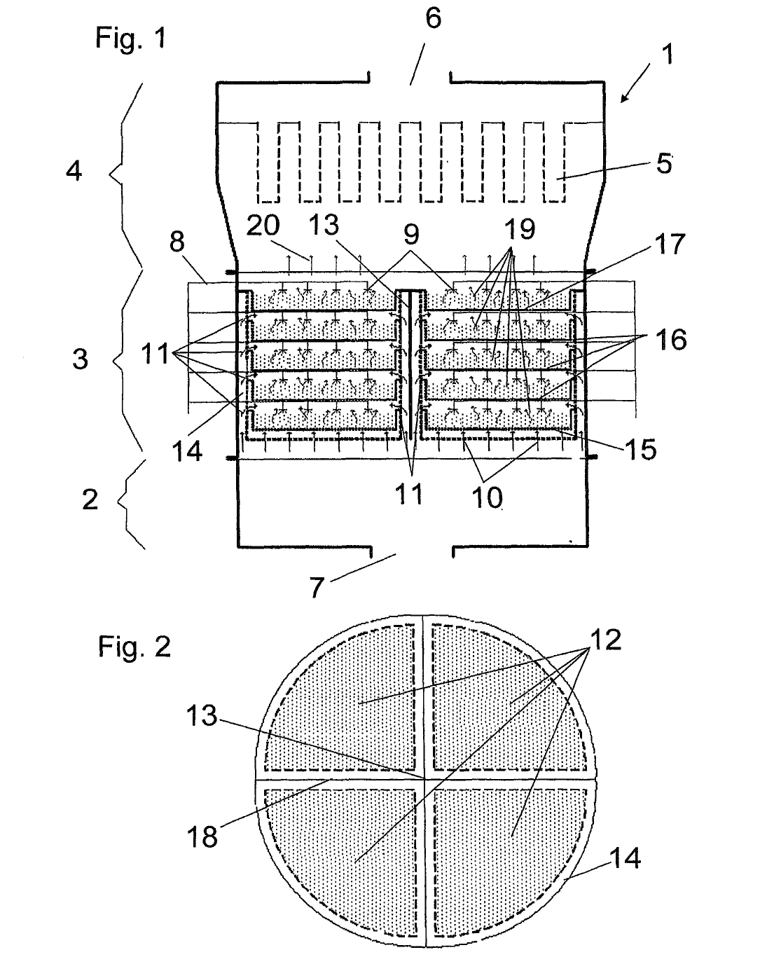

FIG. 1: a drying apparatus according to the invention, in section, and

FIG. 2: a cross-section of the drying apparatus according to the invention according to FIG. 1.

In FIG. 1, a drying apparatus 1 according to the invention, for drying of plant material, such as, for example, fruits, spices, plants, herbs, and the like, is shown. The drying apparatus 1 preferably has a circular cross-section and consists of an inflow housing 2 with a process space 3 that lies above it, and an exhaust air housing 4. The inflow housing 2 is provided with a gas inlet 7 for the drying gas, while a gas outlet 6 the drying gas 20 charged with moisture is disposed on the exhaust air housing 4. A filter 5 is disposed within the exhaust air housing 4, to clean the drying gases 20 charged with moisture by way of the gas outlet 6.

In the process space 3 of the drying apparatus 1, multiple trays 15, 16, 17 are disposed one on top of the other. The trays 15, 16, 17 have the same design configuration, whereby the bottommost tray is referred to as 15, the uppermost tray is referred to as 17, and the trays that lie between the trays 15 and 17 are referred to as 16. The number of trays 16 is dependent on the materials or products to be dried and the amount of drying gas supplied.

The trays 15, 16, 17 are divided into multiple segments 12, in each instance. As is evident from FIG. 2, the trays 15, 16, 17 are divided into four segments 12, in each instance. A different division of the trays 15, 16, 17 into corresponding segments 12 is certainly possible. The segments 12 of the individual trays 15, 16, 17, are structured to be gas-permeable with regard to a first part of a drying gas 10 that is supplied by way of a gas inlet 7, so that the first part of the drying gas 10 flows through the bottommost tray 15, the trays 16 disposed above it, and the uppermost tray 17, one after the other. The segments 12 on which the material 19 to be dried lies, distributed over them, consist of lattices, grids, perforated metal sheets, baskets, or the like. The segments 12 of the trays 15, 16, 17 are suspended in the process space 3 so as to be moved by means of chains, belts, or the like, so that the segments 12 can be moved in the process space 3 with a corresponding drive. In this way, a gentle change in position of the material 19 to be treated, on the segments 12, can be undertaken, so that the material 19 can be uniformly dried by means of the drying gases 10, 11.

An edge channel 14, a central channel 13, and multiple transverse channels 18 are disposed in the process space 3 to supply a second part of the drying gases 11 to the individual segments 12 of the trays 16 and the uppermost tray 17. In this connection, the channels 13, 14, and 18, which are connected with one another, are disposed in such a manner that a part of the second part of the drying gas 11 is supplied to the individual trays 16 and the tray 17 from the bottom, in each instance.

One or more spray nozzles 9 of a spray device 8 for spraying a solvent and/or additional components onto the material 19 to be dried are assigned to the segments 12 of the trays 15, 16, 17, in each instance. Alcohol, water, or a mixture of alcohol and water are used as solvents. Flavors, dyes, waxes, or silicone, for example, are sprayed onto the material 19 for flavoring, coloring, additional curing, or for changing the surface structure, as additional components. In this connection, the solvents are preferably sprayed onto the material 19 during the drying process, and the additional components are sprayed on at the end of the drying process.

The method of effect of the apparatus according to the invention will be described using the method according to the invention. The material 19 to be dried, such as, for example, fruits, spices, plants, herbs, and the like, is introduced onto the segments 12 of the trays 15, 16, 17, which are disposed individually one on top of the other, of the drying apparatus 1. In this connection, the material 19 is introduced onto the segments 12 as a fresh product or as a product that has already been placed in a solvent. In this connection, the material 19 is placed in alcohol, water, or a mixture of alcohol and water before the actual drying process. The water contained in the material dissolves in the alcohol, while at the same time, the cell walls of the material are stabilized by the alcohol. In the case of material 19 introduced in the fresh state, which was not previously treated with a solvent, the solvent, such as tempered alcohol, for example, can be supplied to the process space 3 of the drying apparatus 1 by means of spraying it in or drawing it in.

To dry the material 19, a first part of the drying gas 10 is supplied to the bottommost tray 15, distributed over the cross-section. The drying gas 10 flows through the individual trays 15, 16, 17 from bottom to top, because of the openings in the individual segments 12, whereby the drying gas 10 takes up the moisture of the material 19 lying on the trays 15, 16, 17. So that the moisture content of the drying gas that flows through the trays 15, 16, 17 has approximately the same value, in each instance, a second part of the drying gas 11 is supplied to each tray 16, 17 that lies above the bottommost tray 15 as a dry partial gas stream. Supply of the partial gas stream of the drying gas 11 to the individual trays 16, 17 takes place, in this connection, by way of the edge channel 14 and the central channel 13, in connection with the transverse channels 18 assigned to the trays 16 and 17, in each instance. Before the partial gas streams of the drying gas 11 flow through the individual trays 16, 17, they are mixed with the drying gas 10, which has flowed through the tray that lies underneath, in each instance. In this way, it is guaranteed that the drying speed on the individual trays 15, 16, 17, in each instance, is made uniform by means of mixing the drying gas 10 with the drying gas 11. The division of the size ratios of the drying gases into the drying gas stream 10 and into the drying gas stream 11 takes place by means of the size and number of the openings present in the segments 12 and by means of the cross-section of the central channel 13 and of the edge channel 14, in each instance.

After having flowed through the uppermost tray 17 and the material layer 19 that lies on it, the entire drying gas 20 charged with moisture is conducted out of the drying apparatus 1, after flowing through the filter 5, by way of the gas outlet 6. After water removal from and drying of the drying gas 20 charged with moisture, the gas is passed back to the inflow housing 2, as drying gas. Newly dehumidified air and/or heated, conditioned air can also be used as drying gas, each time.

A solvent or an additional material component is sprayed onto the material 19 situated on the individual trays 15, 16, 17, by way of the spray nozzles 9 of the spray device 8. Furthermore, the solvent that has been precipitated from the drying gas 20 after the drying process can be sprayed onto the materials 19 to be dried, once again, by way of the spray nozzles 9, for flavoring of the materials 19 to be dried.

Drying of the materials 19 in the drying apparatus 1 can take place under partial vacuum or vacuum.

### LISTING OF REFERENCE SYMBOLS USED

1 drying apparatus

2 inflow housing

3 process space

4 exhaust air housing

5 filter

6 gas outlet

7 gas inlet

8 spray device

9 spray nozzle

10 first part of the drying gas

11 second part of the drying gas

12 segments

13 central channel

14 edge channel

15 lower tray

16 tray

17 upper tray

18 transverse channel

19 material

20 drying gases charged with moisture

1. Method for drying of plant material by means of a drying gas stream supplied to a drying apparatus,
wherein
the material (19) to be dried is distributed onto multiple trays (15, 16, 17) of the drying apparatus (1), disposed one on top of the other, through which gas can flow,
a first part of the drying gas (10) is supplied to the bottommost tray (15), distributed over the cross-section, and flows through the individual trays (15, 16, 17) from bottom to top, absorbing the moisture of the material (19),
a second part of the drying gas (11) is supplied to each tray (16, 17) that lies above the bottommost tray (15), as a dry partial gas stream, which flows through the tray (16, 17) that lies above, in each instance, and the material layers (19) that lie on them, in each instance, together with the first part of the drying gas (10), and
after having flowed through the uppermost tray (17) and the material layer (19) that lies on it, the entire drying gas (20) charged with moisture is conducted out of the drying apparatus (1).

2. Method according to claim 1,
wherein
the materials (19) to be dried contain a solvent, such as alcohol, water, or a mixture of alcohol and water, which is absorbed by the drying gases (10, 11).

3. Method according to claim 1,
wherein
for flavoring or subsequent treatment of the materials (19) to be dried, at least a part of the solvent separated out of the drying gases (20) is sprayed onto the materials (19) to be dried, by means of a spray device (8).

4. Method according to claim 1,
wherein
for flavoring or subsequent treatment of the materials (19) to be dried, any desirable liquids are sprayed onto the materials (19) to be dried, by means of a spray device (8).

5. Method according to
claim 1, wherein
the drying gas (10, 11) is dehumidified and/or heated, conditioned air.

6. Method according to
claim 1, wherein
a solvent, such as tempered alcohol, is supplied to the drying apparatus (1), by spraying or drawing it in.

7. Method according to
claim 1, wherein
the drying of the materials (19) in the drying apparatus (1) takes place under partial vacuum or vacuum.

8. Apparatus for drying of plant material by means of a drying gas stream supplied to a drying apparatus,
wherein
multiple trays (15, 16, 17) through which a first part of a drying gas (10) can flow are disposed in a process space (3) of the drying apparatus (1), lying one on top of the other, which trays are divided into multiple segments (12), in each instance, and with at least one edge channel (14), at least one central channel (13), and multiple transverse channels (18) disposed on them, to supply a second part of a drying gas (11) below the segments (12) of the individual trays (16, 17), in the process space (3), in each instance, which channels are connected with one another.

9. Apparatus according to claim 8,
wherein
one or more spray nozzles (9) for spraying a solvent such as alcohol, water, or a mixture of alcohol and water, and/or additional components, such as flavors, dyes, waxes, or silicone, onto the material (19) to be dried, are disposed in the segments (12) of the trays (15, 16, 17), in each instance.

10. Apparatus according to
claim 1, wherein the segments (12) of the trays (15, 16, 17) for placement of the material (19) to be dried are formed by lattices, grids, perforated sheets, or baskets.

11. Apparatus according to
claim 1, wherein
the segments (12) of the trays (15, 16, 17) are suspended in the process space (3) so that they can be moved by means of chains, belts, or the like.

12. Apparatus according to
claim 1, wherein
the drying apparatus (1) has a circular cross-section, in which a gas inlet (7) for the drying gas (10, 11) is disposed in the lower region, and a gas outlet (6) for the drying gas (20) charged with moisture is disposed in the upper region.

13. Apparatus according to
claim 1, wherein
the drying apparatus (1) is operated by batches or continuously.
